(19) United States
(12) Patent Application Publication
(10) Pub. No.: US 2026/0135360 A1
(43) Pub. Date: May 14, 2026

(54) WIRE ROUTING BRACKET

(71) Applicant: Arlington Industries, Inc., Scranton, PA (US)

(72) Inventors: Thomas J. Gretz, Delray Beach, FL (US); Richard Temblador, Clarks Summit, PA (US); Steve Finnerty, South Abington Township, PA (US)

(73) Assignee: Arlington Industries, Inc., Scranton, PA (US)

(21) Appl. No.: 19/362,369

(22) Filed: Oct. 18, 2025

Related U.S. Application Data
(63) Continuation-in-part of application No. 18/945,731, filed on Nov. 13, 2024.

(51) Int. Cl. H02G 3/04; H02G 3/34

(52) U.S. Cl. CPC H02G 3/0481; H02G 3/34

(57) ABSTRACT

A wire routing bracket including a cable receiving plate having a plurality of cable openings, a base plate, and a tie-off structure at each of the cable openings. A collar around the periphery of each cable opening provides support and imparts a gentle bend radius to any cables or conduit that are suspended through one or more of the wire routing brackets. The cable openings are numbered on each side and of the plate for ease of pull planning of cables/conduit through the cable openings. to for securing cables or conduit as they are fed through the various cable openings. The wire routing bracket will support both conduit and cable supplying either electrical power, data, communications, video, or controls, and simplifies applications in that one bracket can be used for commercial or residential applications, conduit or cable, electrical or low voltage applications.

### CROSS-REFERENCE TO RELATED APPLICATIONS

This application is a Continuation-In-Part of U.S. patent application Ser. No. 18/945,731, which was filed on Nov. 13, 2024 and is incorporated herein in its entirety. This application claims the benefit of U.S. Patent Application No. 63/632343, which was filed on Apr. 10, 2024 and is incorporated herein in its entirety.

### BACKGROUND OF THE INVENTION

Electrical wiring or cables are commonly used to supply electrical power throughout buildings. At times it is challenging to support such cables and wires to the building structure. Many installers simply use staples or straps to attach cables to joists, rafters, or similar structures. Unfortunately, there is a concern that staples and straps may disrupt or damage the cable or wiring sheaths, possibly compromising the wiring circuit.

Accordingly, there is a need for an improved wire routing bracket that simplifies the installation of electrical wiring or cables while minimizing damage to the wiring or cables. The bracket should be capable of mounting both conduit and cable suppling either electrical power, data, communications, video, and/or controls.

### BRIEF SUMMARY OF THE INVENTION

The invention is a wire routing bracket including a cable receiving plate and a base plate. A plurality of cable openings are provided in the cable receiving plate. The bracket can be used for both conduit and cable suppling either electrical power, data, communications, video, controls, etc. A collar extends around the periphery of each cable opening. The collar provides a gentle bend radius to any cables inserted through the cable openings. The gentle bend radius minimizes the possibility of damage to cable insulation or the conductors within the cables. The wire routing bracket simplifies applications in that one bracket can be used for commercial or residential applications, conduit or cable, electrical or low voltage applications. This not only simplifies applications it reduces material handling and labor.

### BRIEF DESCRIPTION OF THE SEVERAL VIEWS OF THE DRAWING(S)

Reference is made herein to the accompanying drawings, which are not necessarily drawn to scale, and wherein:

FIG. 1 is a front isometric view of a wire routing bracket according to the invention.

FIG. 2 is an isometric view of the wire routing bracket from an opposing side as that shown in FIG. 1.

FIG. 3 is a front elevation view of the wire routing bracket.

FIG. 4 is a rear elevation view of the wire routing bracket.

FIG. 5 is a sectional view of the wire routing bracket taken along line 5-5 of FIG. 3.

FIG. 6 is a side view of the wire routing bracket.

FIG. 7 is a top view of the wire routing bracket.

FIG. 8 is an isometric view illustrating a method of securing the wire routing bracket to an I-beam using beam clamps.

FIG. 9 is a side view illustrating the method of securing the wire routing bracket to an I-beam using beam clamps.

FIG. 10 is an isometric view illustrating a method of securing the wire routing bracket using a threaded rod secured to the base plate.

FIG. 11 is an isometric view illustrating a method of securing the wire routing bracket to a wood joist.

FIG. 12 is a rear isometric view of the wire routing bracket according to the invention.

FIG. 13 is a front isometric view of a second embodiment of a wire routing bracket according to the invention.

FIG. 14 is a rear isometric view of the second embodiment of the wire routing bracket.

FIG. 15 is a top view of the wire routing bracket of FIG. 13.

FIG. 16 is a front elevation view of the wire routing bracket FIG. 13.

FIG. 17 is an end view of the second embodiment of the wire routing bracket.

FIG. 18 is a rear elevation view of the wire routing bracket FIG. 13.

FIG. 19 is a sectional view of the wire routing bracket taken along line 19-19 of FIG. 18.

FIG. 20 is a rear isometric view of a third embodiment of a wire routing bracket according to the invention.

FIG. 21 is a rear isometric view of a fourth embodiment of a wire routing bracket according to the invention.

FIG. 22 is a front isometric view of a third embodiment of a wire routing bracket according to the invention.

FIG. 23 is a rear isometric view of the third embodiment of the wire routing bracket.

FIG. 24 is a front elevation view of the third embodiment of the wire routing bracket.

FIG. 25 is a rear elevation view of the third embodiment of the wire routing bracket.

FIG. 26 is a top view of the third embodiment of the wire routing bracket.

FIG. 27 is a bottom view of the wire routing bracket.

FIG. 28 is a side view of the wire routing bracket.

FIG. 29 is a sectional view of the wire routing bracket taken along line 29-29 of FIG. 24.

FIG. 30 is a front isometric view of a fourth embodiment of a wire routing bracket according to the invention.

### DETAILED DESCRIPTION OF THE INVENTION

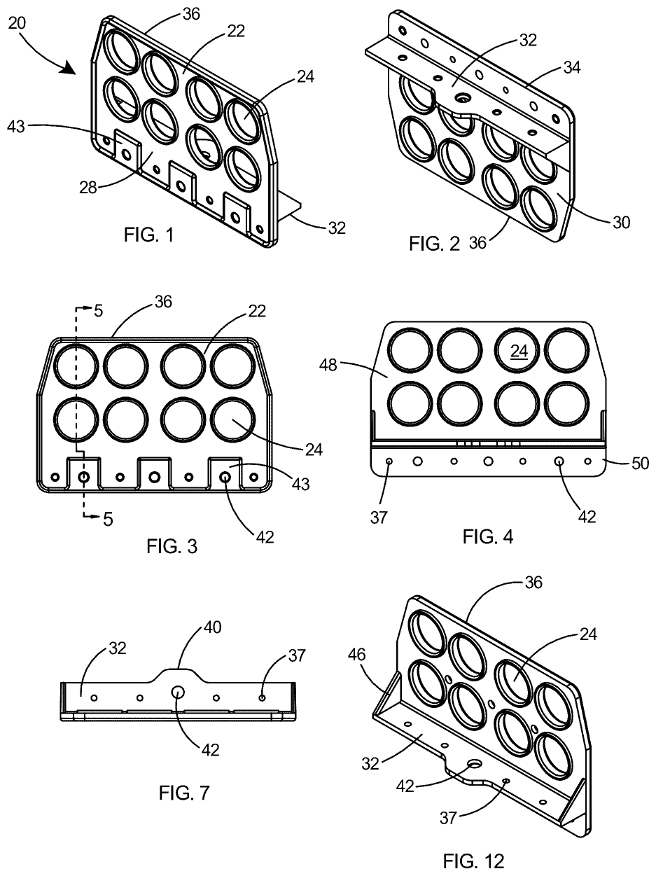

With reference to FIGS. 1-7, there is shown a wire routing bracket according of the present invention that simplifies the installation of electrical wiring or cables while simplifying planning and application, reducing materials and material handling labor, and increased installation efficiency for conduit and cable installations for power or low voltage applications.

The wire routing bracket 20 includes a cable receiving plate 22 with a plurality of apertures therein, including one or more cable openings 24 therein. The wire routing bracket 20 includes a first side 28 and a second side 30. A base plate 32 extends along the second side 30 of the cable receiving plate 22.

With reference to FIGS. 1 and 2, the cable receiving plate 22 includes a proximal end 34 and a distal end 36. As shown in FIG. 2 base plate 32 extends along the second side 30 of the cable receiving plate 22 substantially near the proximal end 34 of the cable receiving plate 22. As shown in FIG. 7, the cable receiving plate 22 and the base plate 32 include one or more apertures 37 for receipt of fasteners 64 for anchoring the cable receiving plate 22 to a support structure, such as a wood joist 68 (see FIG. 11).

With reference to FIG. 7, a tab 40 extending from the base plate 32 includes one or more apertures 42 therein Apertures 42 are of a diameter to receive a threaded support rod 44 (see FIG. 10) for anchoring the wire routing bracket 20 to a structure. One or more apertures 37 are also provided adjacent the proximal end 34 of the cable receiving plate 22 for receipt of fasteners 64 (see FIG. 11) for anchoring the cable receiving plate 22 to a support structure. As shown in FIG. 3, each aperture 42 is in a reinforced area 43 on the first side 28 of the cable receiving plate 22 with each reinforced area 43 extending from the proximal end 34 of the cable receiving plate 22. The reinforced area 43 is preferably a thick wall portion on the cable receiving plate 22.

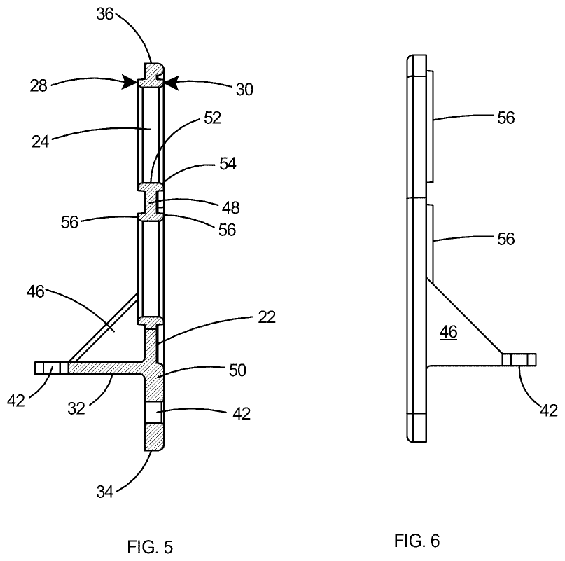

Referring to FIGS. 5 and 6, a brace 46 extends from each end of the base plate 32 to the cable receiving plate 22 to strengthen and stiffen the base plate 32 with respect to the cable receiving plate 22. The cable receiving plate 22 includes a plate wall 48 extending from the proximal end 34 to the distal end 36. A flange 50 extends from the proximal end 34 of the cable receiving plate 22 to the base plate 32, the flange 50 is thicker than the plate wall 48. A peripheral wall 56 extends around the periphery of each cable opening 24. The periphery of the cable openings include a central portion 52 that is substantially flat, and beveled end portions 54 which impart a gentle bend radius to any cables inserted in the cable openings.

As shown in FIG. 10 the aperture 42 in the base plate 32 is of a diameter to receive a threaded support rod 66 (see FIG. 10). The placement of the aperture 42 in the base plate 32 in relation to the cable openings 24 is critical. The aperture 42 in the base plate 32 is positioned such that a threaded rod can pass through longitudinally from either the proximal end 34 or the distal end 36 while avoiding contact with any conduits or cables placed or pulled through any cable opening 24.

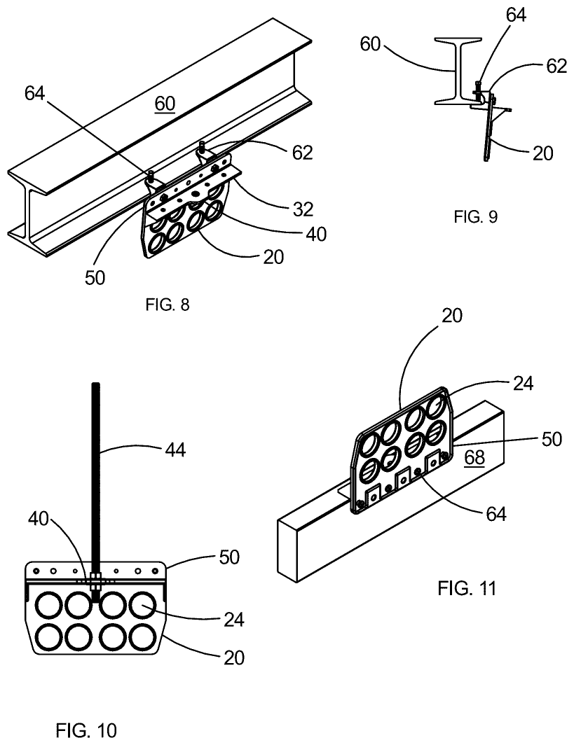

Referring to FIGS. 8 and 9, the wire routing bracket 20 may be secured to an I-beam 60 using beam clamps 62 and fasteners 64. Alternative means of attaching the wire mounting bracket include securing to a threaded support rod 44, as shown in FIG. 10, or securing it to a support beam 68 as shown in FIG. 11.

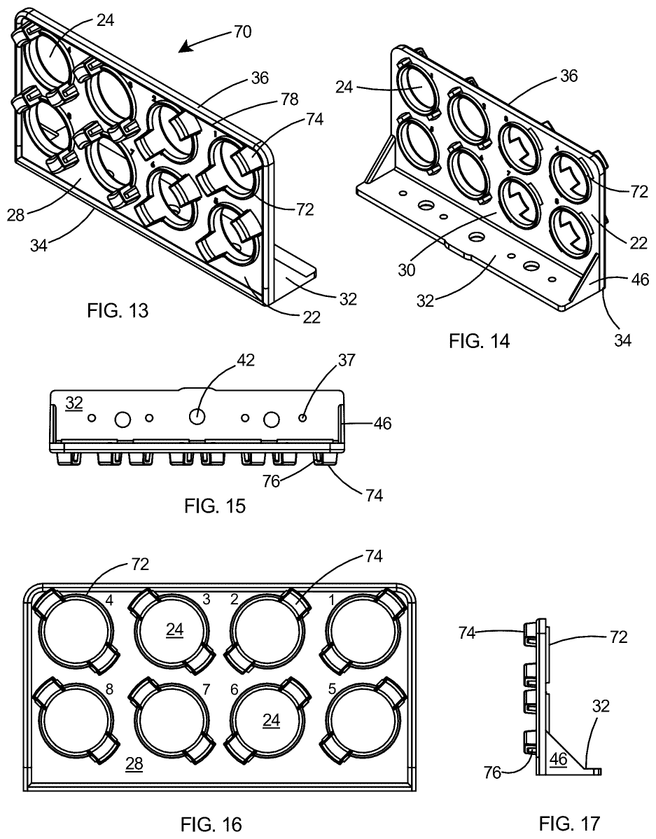

With reference to FIGS. 13-21, wherein elements in common with the first embodiment include the same reference numbers, there is shown a second embodiment of a wire routing bracket 70 according to the invention. The second embodiment of the wire routing bracket 70 includes several elements in common with the first embodiment including a cable receiving plate 22 with one or more cable openings 24 therein. The wire routing bracket 20 also includes a first side 28 and a second side 30.

Wire routing bracket 70 includes a proximal end 34 and a distal end 36. The base plate 32 extends along the second side 30 of the cable receiving plate 22 at the proximal end 34 of the plate. Thus as shown in the end view of FIG. 17, the second embodiment of the wire routing bracket is a substantially L-shaped bracket with the cable receiving plate 22 forming the long side of the “L” and the base plate 32 forming the short side of the “L”.

A collar 72 extends around the periphery of each cable opening 24 and from each side 28 and 30 of the cable receiving plate 22. The collar 72 is wider than the cable receiving plate 22 and will provide a gentle bend radius to any wires or cables extending through the cable openings 24, and will better support to any conduit extending through the cable openings 24.

A wire tie structure 74 extends from the cable receiving plate 22 at 180° apart of each cable opening 24. Each wire tie structure 74 includes a cable/conduit securement slot 76 for insertion of a zip tie, if desired (not shown) to secure the cables, wires, or conduit to the wire routing bracket 70. As shown in FIG. 13, a perimeter 78, of greater thickness than the cable receiving plate 22 extends around the periphery of the cable receiving plate 22.

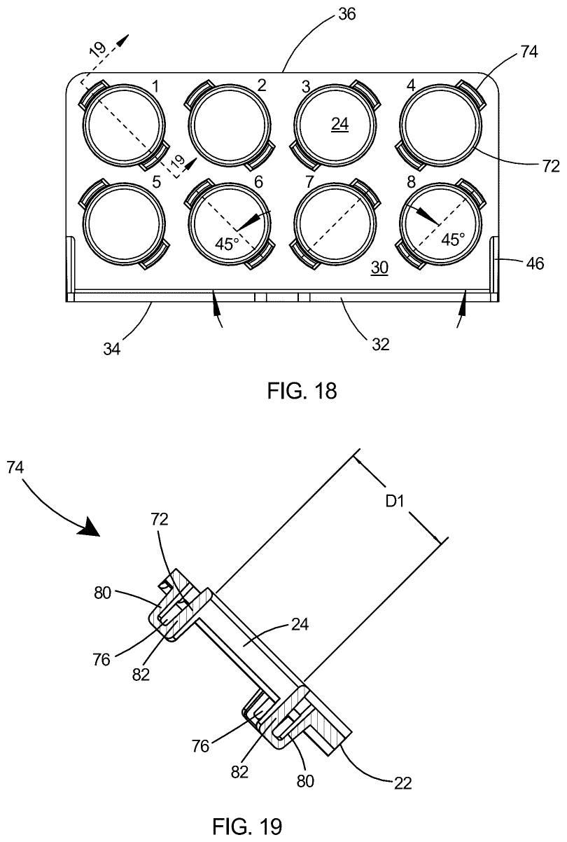

As shown in FIGS. 16 and 18, the cable openings 24 are numbered on each side 28 and 30 of the plate 22 for pull planning of cables/conduit through the cable openings 24.

With reference to FIG. 19, each wire tie structure 74 surrounding a cable opening 24, of diameter D1, includes a cable/conduit securement slot 76 for insertion of a zip tie (not shown) therein. Each wire tie structure 74 includes an outer leg 80 and an inner leg 82 that are integral with the cable receiving plate 22.

As shown in FIG. 18, the legs of the wire tie structure 74 substantially match the curvature of the respective cable openings 24. The cable/conduit securement slots 76 are 180° apart with respect to the cable opening and can accommodate a zip tie for securing cables or conduit to the wire routing bracket. The wire tie structures 74 on the right half of the cable receiving plate 22, as viewed from the second side, are at an angle of 45° with respect to the base plate 32 and the wire tie structures 74 on the left half of the cable receiving plate 22, as viewed from the second side, are at an angle of 315° with respect to the base plate 32.

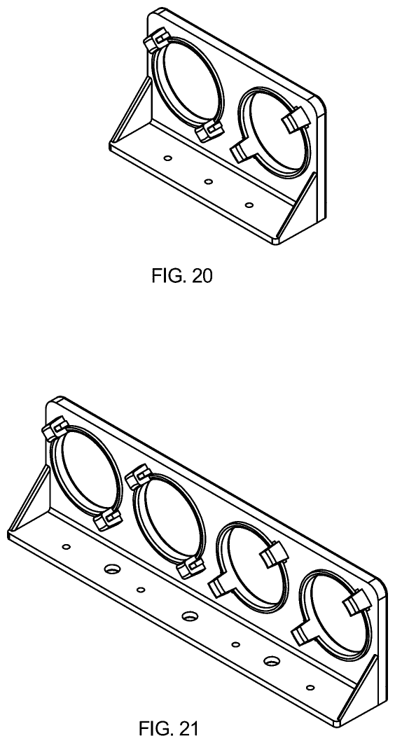

FIGS. 20 and 21 Illustrate That Other embodiments of wire routing brackets can be produced with more or less cable openings 24 than the wire routing brackets 20 and 70 of FIGS. 1-19.

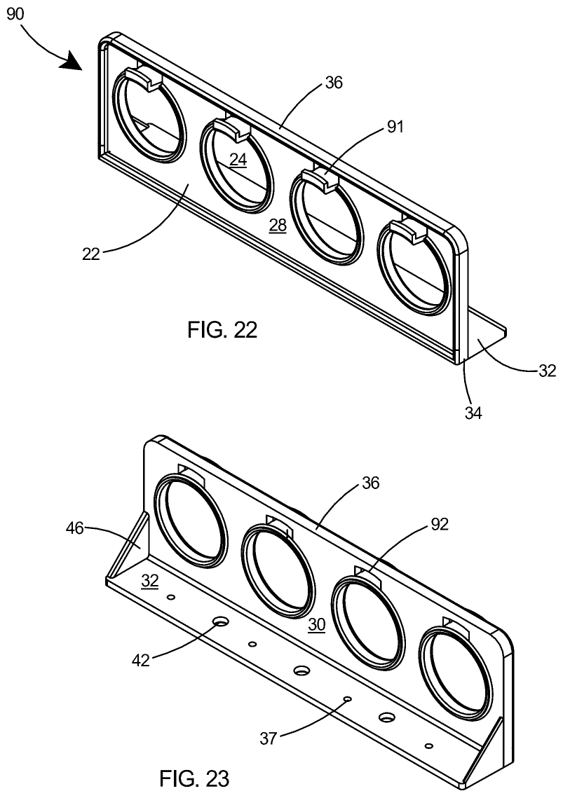

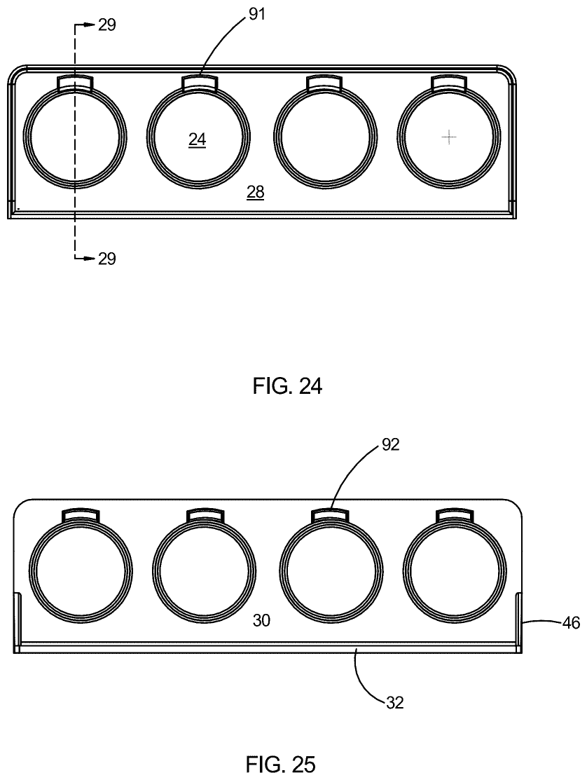

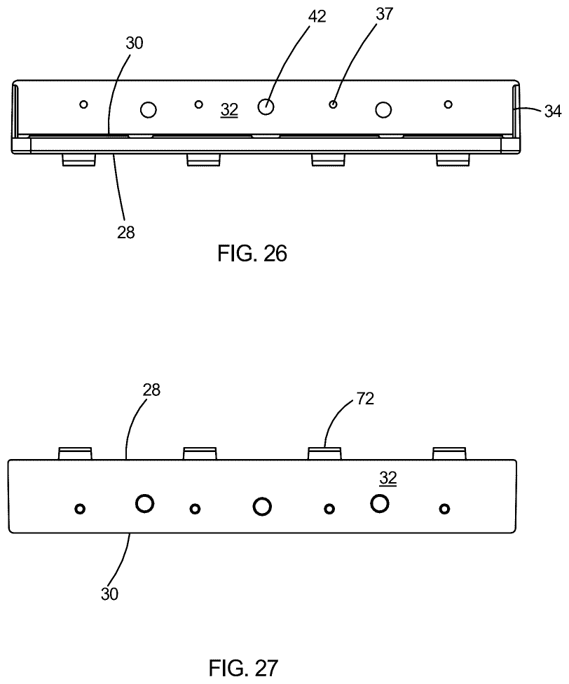

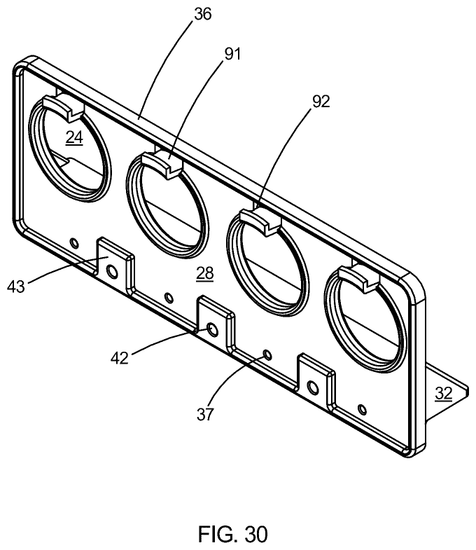

With reference to FIGS. 22-30, wherein elements in common with the first embodiment include the same reference numbers, there is shown a third embodiment of a wire routing bracket 90 according to the invention. The third embodiment of the wire routing bracket 90 includes several elements in common with the first embodiment including a cable receiving plate 22 with one or more cable openings 24 therein. The first side 28 of the plate 22 includes a wire tie structure 91 having an associated cable/conduit securement slot 92 extending through the plate 22 for insertion of a zip tie, if desired (not shown) to secure the cables, wires, or conduit to the wire routing bracket 90.

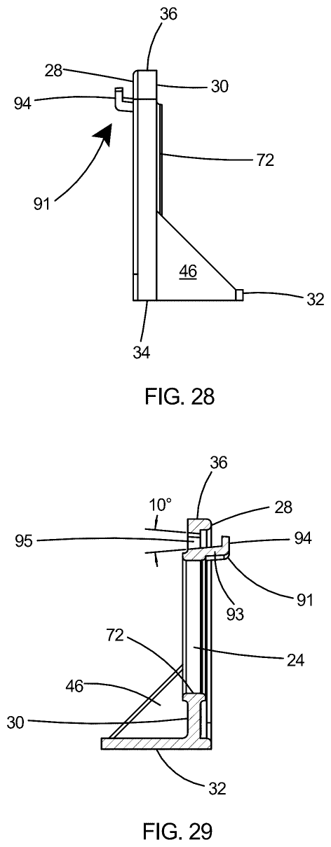

Referring to FIGS. 28 and 29, a collar 72 extends around the periphery of each cable opening 24. The collar 72, being wider than the cable receiving plate 22, will provide better support to any wires or cables that are pulled through the cable openings 24 in successive brackets. As shown inf FIG. 29, the collar 72 extends from both sides of the plate 22. The wire tie structure 91 includes a first leg 93 extending outward from the first side of the plate and an upward leg 94 extending from the first leg 93 upward toward the distal end 36 of the plate. The slot 92 preferably slopes 10° to form a wider slot on the second side 30 of the plate 22 as compared to the slot opening on the first side 28 of the plate.

Another key feature involves positioning multiple cable openings 24 to increase the density of conduit that can be installed in the same space or area as compared to conventional cable and conduit support systems.

The wire routing bracket of the current invention is constructed for use in both residential and commercial applications; is plenum rated for NEC 300.22(c) environmental air handling spaces, includes a wide edge border around each conduit/cable hole, and provides a low material cost and a low installed cost option for conduit, MC cable and low voltage cable backbone installations. The bracket further provides versatility and flexibility as one bracket works for power, data and signal cables and conduit.

The wire routing bracket of the current invention may be mounted to various surfaces, including wood studs or joists, steel studs (25 Gauge), threaded rods (⅜″), or beam clamps, such as a UNISTRUT®, available from Universal International Corporation, 4205 Elizabeth Street, Wayne, Michigan 48184, United States.. The wire routing bracket two cable/conduit securement slots per hole that are 180° apart and can accommodate a zip tie.

The description of the present invention has been presented for purposes of illustration and description, but is not intended to be exhaustive or limited to the invention in the form disclosed. Many modifications and variations will be apparent to those of ordinary skill in the art without departing from the spirit of the invention. The embodiment was chosen and described in order to best explain the principles of the invention and the practical application, and to enable others of ordinary skill in the art to understand the invention for various embodiments with various modifications as are suited to the particular use contemplated.

I claim:

1. A wire routing bracket, comprising:
a cable receiving plate including a plate wall having a first side and a second side and a proximal end and a distal end;
a base plate extending from the second side of said plate wall at said proximal end of said cable receiving plate; and
said base plate at substantially a right angle with respect to said cable receiving plate.

2. The wire routing bracket of claim 1 comprising one or more cable openings in the cable receiving plate.

3. The wire routing bracket of claim 2 comprising;
a collar extending around the periphery of each of said cable openings; and
said collar extending outward from each side of the cable receiving plate.

4. The wire mounting plate of claim 3 comprising each of said cable openings are numbered with the numeral displayed in close proximity to each of said cable openings on each side of the plate.

5. The wire routing bracket of claim 2 comprising a wire tie structure at each of one or more cable openings on said first side of said cable receiving plate.

6. The wire routing bracket of claim 5 comprising said wire tie structure having a first leg first leg extending outward from the first side of the plate.

7. The wire routing bracket of claim 6 comprising an upward leg extending from the first leg upward toward the distal end of the cable receiving plate.

8. The wire routing bracket of claim 7 comprising a slot extending through the cable receiving plate.

9. The wire routing bracket of claim 8 comprising said slot slopes 10° to form a wider slot on the second side of the plate as compared to the slot opening on the first side of the plate.

10. The wire routing bracket of claim 1 comprising a brace extending from each end of the base plate to the cable receiving plate.

11. The wire routing bracket of claim 1 comprising one or more apertures extending through the cable receiving plate.

12. The wire routing bracket of claim 1 comprising:
one or more reinforced areas on the cable receiving plate; and
said reinforced areas including an aperture therein.
